(19) United States
(12) Patent Application Publication
(10) Pub. No.: US 2025/0293266 A1
(43) Pub. Date: Sep. 18, 2025

(54) ELECTRODE

(71) Applicant: DENSO CORPORATION, Kariya-city (JP)

(72) Inventors: Satoru FUJITA, Nagakute-shi (JP); Akira MORIKAWA, Nagakute-shi (JP); Tadashi INABA, Nagakute-shi (JP); Tetsuro KOBAYASHI, Nagakute-shi (JP); Kazuhiro FUKUMOTO, Nagakute-shi (JP); Naohiro HAYASHI, Kariya-city (JP); Takuma HITOMI, Kariya-city (JP)

(73) Assignee: DENSO CORPORATION, Kariya-city (JP)

(21) Appl. No.: 19/081,789

(22) Filed: Mar. 17, 2025

(30) Foreign Application Priority Data
Mar. 15, 2024 (JP) 2024-040864
Dec. 12, 2024 (JP) 2024-218091

(51) Int. Cl. H01M 4/86; C25B 11/031; C25B 11/037; C25B 11/047; C25B 13/07; H01M 4/90; H01M 8/12; H01M 8/126

(52) U.S. Cl. CPC H01M 4/8657; C25B 11/031; C25B 11/037; C25B 11/047; C25B 13/07; H01M 4/8605; H01M 4/9025; H01M 8/126; H01M 2008/1293; H01M 2300/0071

(57) ABSTRACT

An electrode includes electrolyte particles and Ni-based particles. The electrolyte particles contain Gd-doped CeO₂ (GDC) and/or Gd- and La-doped CeO₂ (La-GDC). The Ni-based particles are composed of core-shell particles in which a surface of a core composed of Ni or a Ni-based alloy is partially or fully covered by a shell composed of a composite oxide containing NiO or Ni.

### CROSS-REFERENCE TO RELATED APPLICATIONS

This application is based on and claims the benefit of priority from Japanese Patent Application No. 2024-040864, filed on Mar. 15, 2024, and Japanese Patent Application No. 2024-218091, filed on Dec. 12, 2024, the descriptions of which are incorporated herein by reference.

### BACKGROUND

### Technical Field

The present disclosure relates to an electrode. More specifically, the present disclosure relates to an electrode that is suitable as a fuel electrode for a solid oxide electrolyzer cell (SOEC) or a fuel electrode for a solid oxide fuel cell (SOFC).

### Related Art

A SOFC is a fuel cell that uses an oxide ion conductor as an electrolyte. When an anode (fuel electrode) of the SOFC is supplied with a fuel gas such as H₂, CO, or CH₄ and a cathode (oxygen electrode) is supplied with O₂, an electrode reaction progresses and electrical power can be extracted. CO₂ and H₂O produced by the electrode reaction are discharged outside the SOFC.

Meanwhile, although structurally identical to the SOFC, the SOEC causes a reaction opposite that of the SOFC. That is, the cathode (fuel electrode) of the SOEC is supplied with CO₂ and H₂O, and CO and H₂ can be produced by a current being sent between the electrodes.

### SUMMARY

One aspect of the present disclosure provides an electrode that includes electrolyte particles and Ni-based particles. The electrolyte particles contain Gd-doped CeO₂ (GDC) and/or Gd- and La-doped CeO₂ (La-GDC). The Ni-based particles are composed of core-shell particles in which a surface of a core composed of Ni or a Ni-based alloy is partially or fully covered by a shell composed of a composite oxide containing NiO or Ni.

### BRIEF DESCRIPTION OF THE DRAWINGS

In the accompanying drawings:

FIG. 1 is a schematic diagram illustrating electrode degradation in a conventional fuel electrode;

FIG. 2 is a schematic diagram illustrating a process in which electrode activity is maintained by Ni-based particles having a core-shell structure;

FIG. 3 is a schematic diagram illustrating an electrolysis cell used for impedance measurement;

FIG. 4 is a diagram illustrating an example of impedance analysis results;

FIG. 5 is a diagram illustrating an example of changes over time in a resistance change ratio of sample No. 1;

FIG. 6 is a graph illustrating degradation rates of electrodes of sample No. 1 and sample No. 2 at each temperature;

FIG. 7 is an SEM image of an electrode cross-section (partial) of sample No. 1 after a durability test (800° C.);

FIG. 8 is an example illustrating SEM/EDS mapping of an electrode cross-section (full: from an electrolyte interface to an electrode surface) of sample No. 1 after a durability test (800° C.);

FIG. 9 is a graph illustrating area ratios of electrode constituent materials of sample No. 1 after a durability test (800° C.);

FIG. 10 is a graph illustrating the area ratios of the electrode constituent materials of sample No. 1 after a durability test (850° C.);

FIG. 11 is a TEM image (left-hand image) and EDS mapping (right-hand image) of sample No. 1 after a durability test (800° C.);

FIG. 12A is a graph illustrating line analysis results when line analysis is performed along an arrow A direction in FIG. 11, and FIG. 12B is a graph illustrating line analysis results when line analysis is performed along an arrow B direction in FIG. 11;

FIG. 13 is a graph illustrating oxygen storage capacities of the electrodes of sample No. 1 and sample No. 2 at each temperature;

FIG. 14 is a graph illustrating a Ni particle change ratio of the electrode of sample No. 1 at each temperature;

FIG. 15 is a graph illustrating the degradation rates of the electrodes of sample No. 3 (La-GDC) and sample No. 1 (GDC) at each temperature;

FIG. 16 is a graph illustrating the oxygen storage capacities of La-GDC and GDC;

FIG. 17 is an SEM image of an electrode cross-section (partial) of sample No. 3 after a durability test (700° C.);

FIG. 18 is an example of SEM/EDS mapping of an electrode cross-section (an area from the electrolyte interface to about 20 μm toward the electrode surface side) of sample No. 3 after a durability test (700° C.);

FIG. 19 is a graph illustrating the area ratios of the electrode constituent materials of sample No. 3 after a durability test (700° C.); and

FIG. 20 is a graph illustrating the area ratios of the electrode constituent materials of sample No. 3 after a durability test (800° C.).

### DESCRIPTION OF THE EMBODIMENTS

The SOEC includes a unit cell in which the anode (air electrode) is coupled to one surface of an electrolyte and the cathode (fuel electrode) is coupled to another surface. As materials for components configuring an SOEC such as this, materials such as those below are typically used (refer to Non-Patent Literatures 1 to 5, below).
(a) Electrolyte: yttria-stabilized zirconia (YSZ), scandia-stabilized zirconia (ScSZ), scandia-yttria-stabilized zirconia (ScYSZ), samaria-doped ceria (SDC), lanthanum strontium gallium magnesium oxide (LSGM), and the like.
(b) Air electrode: lanthanum strontium manganite (LSM), lanthanum strontium cobalt ferrite (LSCF), lanthanum strontium cobaltite (LSC), and the like.
(c) Fuel electrode: Ni/YSZ, Ni/ScYSZ, Ni-Cu/YSZ, and the like.
[Non-Patent Literature 1] Ebbesen, S. D.; Hansen, J. B.; Mogensen, M. B. The Electrochemical Society Transactions 2013, 57, 3217.
[Non-Patent Literature 2] Jensen, S. H.; Larsen, P. H.; Mogensen, M. International Journal of Hydrogen Energy 2007, 32, 3253.
[Non-Patent Literature 3] Ullman, H.; Trofimenko, N.; Stoever, D.; Ahmad-Khanlou, A. Solid State Ionics 2000, 138, 79.
[Non-Patent Literature 4] Laguna-Bercero, M. A.; Skinner, S. J.; Kilner, J. A. Journal of Power Sources 2009, 192, 126.
[Non-Patent Literature 5] Ebbesen, S. D.; Jensen, S. H.; Hauch, A.; Mogensen, M. B. Chemical Reviews 2014, 114, 10697.

Although not a fuel electrode, JP 2018-142419 A discloses an anti-reaction layer for a solid oxide fuel cell in which ceria is doped with more than 10 mol % and less than 30 mol % of GdO_{1.5}.

Although not for the purpose of optimizing fuel electrode materials, JP 2018-085200 A discloses an active layer including a gas flow path for diffusing gas from a diffusion layer toward an electrolyte layer.

A Ni/YSZ cermet is commonly used in the fuel electrode of the SOEC. However, steam serving as a raw material for hydrogen production is supplied to the fuel electrode at a high temperature (700° C. or higher). Therefore, when the SOEC using Ni/YSZ as the fuel electrode is used over a long period of time, electrolytic properties are known to gradually decrease. This is thought to be because, as a result of the fuel electrode being exposed to high-temperature steam, Ni particles are oxidized and become nickel hydroxide, which has low vapor pressure. The nickel hydroxide is then volatilized and dispersed. The structure of the fuel electrode is thought to change as a result.

To solve the above-described issue, various proposals have been made since the past.

For example, JP 2020-155349 A, JP 2021-085061 A, JP 2020-167052 A, and JP 2021-161467 A propose a fuel electrode containing Ni-containing particles and ACZ particles composed of a composite oxide (ACZ) consisting of A₂O₃ (where A=Y, La, and/or Sc), CeO₂, and ZrO₂.

In addition, JP 2022-074189 A proposes an active layer composed of a cermet containing Ni-containing particles and YScCZ particles composed of Y, Sc, and Ce-doped ZrO₂.

However, there are limitations to improvement in durability of the SOEC through optimization of the electrolyte used in the fuel electrode alone.

It is thus desired to provide an electrode in which changes to an electrode structure is minimal even when exposed to high-temperature steam.

One exemplary embodiment of the present disclosure provides an electrode that includes electrolyte particles and Ni-based particles. The electrolyte particles contain Gd-doped CeO₂ (GDC) and/or Gd- and La-doped CeO₂ (La-GDC). The Ni-based particles are composed of core-shell particles in which a surface of a core composed of Ni or a Ni-based alloy is partially or fully covered by a shell composed of a composite oxide containing NiO or Ni.

When a Ni/YSZ electrode is used as the fuel electrode of an electrolysis cell, the Ni/YSZ electrode tends to easily degrade over time. This is thought to be due to morphological changes in electrode reaction sites resulting from gas-phase diffusion of Ni during use.

In contrast, in an electrode containing electrolyte particles composed of GDC and/or La-GDC and Ni-based particles, if a shell composed of a composite oxide (also referred to, hereafter, as a “Ni-based oxide”) containing NiO or Ni is formed on surfaces of the Ni-based particles in advance, degradation of the electrode over time can be suppressed without compromising electrode performance. This is thought to be because GDC or La-GDC extracts oxygen from the Ni-based oxide in a region (three-phase interface) where the Ni-based particle, GDC or La-GDC, and a void overlap, thereby forming a Ni layer or a Ni-based alloy layer in the vicinity of the three-phase interface at all times and enabling function as the electrode reaction site to be continued. In addition, the shell composed of the Ni-based oxide in a region other than the vicinity of the three-phase interface suppresses gas-phase diffusion of Ni, thereby suppressing morphological changes in the electrode reaction sites.

An embodiment of the present disclosure will hereinafter be described in detail.

### 1. Electrode

An electrode of the present disclosure includes electrolyte particles and Ni-based particles.

### 1.1. Electrolyte Particles

The electrolyte particles contain Gd-doped CeO₂ (GDC) and/or Gd- and La-doped CeO₂ (La-GDC).

### 1.1.1. GDC

GDC functions not only as an oxide ion conductor but also as an oxygen storage material. Therefore, in cases in which GDC is used as the electrolyte particles, not only can oxide ions be exchanged with the Ni-based particles during use of the electrode, but morphological changes in electrode reaction sites can be suppressed.

In the present disclosure, the Gd content in GDC is not particularly limited, and an optimal value can be selected based on intended purpose.

Here, the Gd content refers to the proportion of Gd in number of mols relative to the total number of mols of Ce and Gd contained in GDC.

In general, the oxide ion conductivity and the oxygen storage capacity of GDC increase as the Gd content increases. To achieve such effects, the Gd content is preferably greater than 0 mol %, and more preferably equal to or greater than 4 mol % or even more preferably equal to or greater than 8 mol %.

Meanwhile, if the Gd content becomes excessive, the oxide ion conductivity may instead decrease or the oxygen storage capacity decrease. Therefore, the Gd content is preferably equal to or less than 20 mol %, and more preferably equal to or less than 15 mol % or even more preferably equal to or less than 10 mol %.

In particular, GDC preferably has a Gd content of equal to or greater than 4 mol % and 15 mol % or less.

### 1.1.2. La-GDC

La-GDC similarly functions not only as an oxygen ion conductor but also as an oxygen storage material. Therefore, in cases in which La-GDC is used as the electrolyte particles, not only can oxide ions be exchanged with the Ni-based particles during use of the electrode, but morphological changes in the electrode reaction sites can be suppressed. Moreover, La-GDC has a greater effect of suppressing morphological changes in the electrode reaction sites than GDC.

In the present disclosure, the Gd content and the La content in La-GDC are not particularly limited, and optimal values can be selected based on intended purpose.

Here, the “Gd content” refers to the proportion of Gd in number of mols relative to the total number of mols of Ce, Gd, and La contained in La-GDC.

The “La content” refers to the proportion of La in number of mols relative to the total number of mols of Ce, Gd, and La contained in La-GDC.

In La-GDC, the oxide ion conductivity of La-GDC increases as the Gd content increases. To achieve such an effect, the Gd content is preferably greater than 0 mol %, and more preferably equal to or greater than 1 mol % or even more preferably equal to or greater than 2.5 mol %.

Meanwhile, if the Gd content becomes excessive, the oxygen storage capacity may decrease or the oxide ion conductivity reach a ceiling. Therefore, the Gd content is preferably less than 10 mol %, and more preferably equal to or less than 8.5 mol % or even more preferably equal to or less than 7.5 mol %.

In La-GDC, the oxygen storage capacity of La-GDC increases as the La content increases. This is thought to be because, as a result of La³⁺ (ion radius: 0.116 nm) being doped into a crystalline lattice of CeO₂, strain on the crystalline lattice that occurs when Ce⁴⁺ (ion radius: 0.097 nm) is reduced to Ce³⁺ (ion radius: 0.114 nm) decreases. To achieve such an effect, the La content is preferably more than 0 mol %, and more preferably equal to or greater than 1 mol % or even more preferably equal to or greater than 2.5 mol %.

Meanwhile, if the La content becomes excessive, the oxygen storage capacity may decrease. Therefore, the La content is preferably less than 10 mol %, and more preferably equal to or less than 8.5 mol or even more preferably equal to or less than 7.5 mol %.

In particular, La-GDC preferably has a Gd content of equal to or greater than 2.5 mol % and equal to or less than 7.5 mol %, and a La content of equal to or greater than 2.5 mol % and equal to or less than 7.5 mol %.

### 1. 2. Ni-Based Particles

In the present disclosure, the Ni-based particles are composed of core-shell particles in which the surface of a core composed of Ni or a Ni-based alloy is partially or fully covered by a shell composed of a composite oxide containing NiO or Ni.

### 1.2.1. Core

In the electrode, the core functions as a catalyst and an electron conductor. In the present disclosure, the core is composed of Ni or a Ni-based alloy.

When the core is composed of a Ni-based alloy, a type of an alloying element is not particularly limited and may, for example, be Fe or Co.

In addition, when the core is composed of a Ni-based alloy, the Ni content in the core is preferably equal to or greater than 90 mass % and more preferably equal to or greater than 95 mass %.

In particular, the core is preferably Ni or a Ni-Fe alloy.

### 1.2.2. Shell

### A. Shell Composition

The surface of the core is partially or fully covered by the shell. The shell functions to suppress gas-phase diffusion of the Ni contained in the Ni-based particles.

Here, “gas-phase diffusion” of Ni refers to a phenomenon in which, when an electrode containing Ni is exposed to high-temperature steam, the Ni reacts with the steam to form nickel hydroxide, and the nickel hydroxide or decomposition products thereof are diffused within the electrode via the gas phase.

As described hereafter, the shell is formed by the electrode containing the Ni-based particles reduced to a metal state undergoing an oxidation process in a controlled oxidation atmosphere. Therefore, the shell is composed of an oxide containing a metal element constituting the core. More specifically, the shell is composed of a composite oxide (Ni-based oxide) containing NiO or Ni.

Here, in an initial state, the overall surface of the core may be covered by the shell. This is thought to be because, when a current is applied to the electrode, in a region (three-phase interface) in which the Ni-based particle, GDC or La-GDC, and a void (gas phase) overlap, GDC or La-GDC extracts oxygen from the shell, and a Ni layer or a Ni-based alloy layer is formed at all times in the vicinity of the three-phase interface.

### B. Shell Thickness

A thickness of the shell may differ depending on location. The shell is not necessarily required to fully cover the surface of the core and may cover a portion of the core. Even when a portion of the core is covered by the shell, gas-phase diffusion of Ni can be effectively suppressed depending on a coverage ratio of the shell.

Meanwhile, when the overall surface of the core is covered by a thick shell, electrode activity may excessively decrease. Therefore, the shell preferably includes an area that is thinner compared to its surroundings (referred to, hereafter, as a “thin film area”). To achieve high electrode activity, the thickness of the thin film area is preferably equal to or less than 200 nm, and more preferably equal to or less than 150 nm, or even more preferably equal to or less than 100 nm, or even more preferably equal to or less than 50 nm, or even more preferably equal to or less than 40 nm, or even more preferably equal to or less than 30 nm.

In particular, the thin film area is preferably formed in a three-phase interface portion. If the thin film area is formed in the three-phase interface portion, the vicinity of the three-phase interface portion can continue to function as an electrode active site as a result of the oxygen storage capacity of the electrolyte particles.

Here, the “three-phase interface portion” refers to an electrolyte particle/Ni-based particle interface in the vicinity of the three-phase interface or a Ni-based particle/gas phase interface in the vicinity of the three-phase interface.

“In the vicinity of the three-phase interface” refers to an area equal to or less than 300 nm from an electrode reaction site where the three phases that are the electrolyte particle, the Ni-based particle, and the gas phase meet.

### C. Shell Area Ratio

An “area ratio of the shell” refers to a ratio (Sₛₕₑₗₗ/S_{core}) of the area of the shell (Sₛₕₑₗₗ) relative to the area (S_{core}) of the core in a cross-section of the electrode. S_{core} and Sₛₕₑₗₗ can each be calculated by scanning electron microscope (SEM)/energy-dispersive X-ray spectroscopy (EDS) mapping of the cross-section of the electrode.

The area ratio of the shell is correlated with the coverage ratio of the shell on the core surface. If the area ratio of the shell becomes too small, a proportion of exposed core increases. Therefore, gas-phase diffusion of Ni may become difficult to suppress. Therefore, the area ratio of the shell is preferably greater than 0, and more preferably equal to or greater than 0.30, or even more preferably equal to or greater than 0.40, or even more preferably equal to or greater than 0.50, or even more preferably equal to or greater than 0.56.

Meanwhile, if the area ratio of the shell becomes too large, a proportion of the Ni-based oxide occupying the electrode increases and electrode characteristics may decrease. Therefore, the area ratio of the shell is preferably equal to or less than 0.98, and more preferably equal to or less than 0.95 or even more preferably equal to or less than 0.90.

### 1. 3. Electrode Composition

### 1. 3. 1. Ni-Based Particle Content

The “Ni-based particle content” refers to the proportion of Ni-based particles by mass relative to the total mass of the electrolyte particles and the Ni-based particles.

If the Ni-based particle content becomes too small, total cell resistance increases and efficiency of electrode reaction decreases. Therefore, the Ni-based particle content is preferably equal to or greater than 30 mass % and more preferably equal to or greater than 40 mass %.

Meanwhile, if the Ni-based particle content becomes excessive, the electrolyte particle content decreases and the efficiency of electrolyte reaction may instead decrease. Therefore, the Ni-based particle content is preferably equal to or less than 70 mass %.

### 1.3.2. La-GDC Content

The “La-GDC content” refers to the proportion of La-GDC by mass relative to the total mass of GDC and La-GDC contained in the electrode.

In the present disclosure, the La-GDC content is not particularly limited and a suitable content can be selected based on intended purpose. That is, the electrode of the present disclosure may include only either of GDC and La-GDC as the electrolyte particle or may include both. To achieve high durability, the La-GDC content is preferably equal to or greater than 50 mass %, and more preferably equal to or greater than 70 mass % or even more preferably equal to or greater than 90 mass %.

### 1.3.3. Total GDC and La-GDC Content

A “total GDC and La-GDC content” refers to a proportion of GDC and La-GDC by total mass relative to the total mass of electrolyte particles contained in the electrode.

The electrolyte particles may be composed of only GDC and/or La-GDC or may contain other components as well. In general, the durability of the electrode increases as the total GDC and La-GDC content increases. To achieve high durability, the total GDC and La-GDC content is preferably equal to or greater than 80 mass %, and more preferably equal to or greater than 90 mass %, or even more preferably equal to or greater than 95 mass %, or even more preferably equal to or greater than 99 mass %.

### 1. 4. Porosity

“Porosity” refers to a value measured by a mercury porosity meter.

The porosity of the electrode affects electrode characteristics. If the porosity of the electrode is too low, gas diffusibility decreases and the efficiency of electrode reaction may decrease. Therefore, the porosity of the electrode is preferably equal to or greater than 20%, and more preferably equal to or greater than 25%.

Meanwhile, if the porosity of the electrode is too high, the three-phase interface relatively decreases and the efficiency of electrode reaction may instead decrease. Therefore, the porosity of the electrode is preferably equal to or less than 40%, and more preferably equal to or less than 35% or even more preferably equal to or less than 30%.

### 1.5. Characteristics: Degradation Rate

The “degradation rate” refers to the slope A of the straight line ΔR=A×t determined by setting a vertical axis to a resistance change ratio ΔR (%) of the electrode before and after a durability test and a horizontal axis to a durability test time t (h), and connecting the values at t=0 h and 40 h.

The resistance change ratio ΔR (%) refers to a value expressed by a following expression (1).

$$Δ R ( \% ) = \{ Rct 2 ( t ) - Rct 2 ( 0 ) \} \times 100 / Rct 2 ( 0 ) \qquad ( 1 )$$

where Rct2(0) is electrode reaction resistance before the durability test and Rct2(t) is electrode reaction resistance after the durability test of time (t).

The “electrode reaction resistance (Rct2)” refers to reaction resistance at the three-phase interface within the fuel electrode and is a diameter of an arc (second arc) contributing to the electrode reaction obtained by impedance measurement being performed on the electrolysis cell using the electrode as the fuel electrode.

The “durability test” refers to a test in which steam electrolysis is performed over a predetermined amount of time under conditions shown in Table 1 using the electrolysis cell in which the above-described electrode is used as the fuel electrode.

TABLE 1

| | |
|---|---|
| Temperature | 650, 700, 750, 800, 850° C. |
| Fuel electrode* | H₂O/H₂ = 4 (vol %) with nitrogen dilution |
| Energization current | 30 mA (0.06 A/cm²) with constant current control |

*Counter electrode (air electrode): 80% nitrogen + 20% oxygen

In a conventional fuel electrode (Ni/YSZ), morphology of the electrode reaction site easily changes. Therefore, the degradation rate is high. In contrast, the electrode of the present disclosure uses core-shell particles as the Ni-based particles. Therefore, the degradation rate is lower than that of the conventional electrode regardless of temperature during the durability test.

For example, the degradation rate of the conventional electrode at 700° C. is 17.18%/h. In contrast, when the electrolyte particles are composed of only GDC, the degradation rate of the electrode of the present disclosure at 700° C. is equal to or less than 10%/h. If manufacturing conditions are further optimized, the degradation rate at 700° C. is preferably equal to or less than 9%/h or more preferably equal to or less than 8%/h.

In a similar manner, the degradation rate of the conventional electrode at 750° C. is 10.25%/h. In contrast, when the electrolyte particles are composed of only GDC, the degradation rate of the electrode of the present disclosure at 750° C. is equal to or less than 6%/h. If manufacturing conditions are further optimized, the degradation rate at 750° C. is equal to or less than 5%/h.

Furthermore, the degradation rate of the conventional electrode at 800° C. is 2.67%/h. In contrast, when the electrolyte particles are composed of only GDC, the degradation rate of the electrode of the present disclosure at 800° C. is equal to or less than 2%/h. If manufacturing conditions are further optimized, the degradation rate at 800° C. is equal to or less than 1.5%/h.

When the electrolyte particles are composed of only La-GDC, the degradation rate of the electrode of the present disclosure at 700° C. is equal to or less than 5%/h. If manufacturing conditions are further optimized, the degradation rate at 700° C. is preferably equal to or less than 4%/h or even more preferably equal to or less than 3%/h.

Furthermore, when the electrolyte particles are composed of only La-GDC, the degradation rate of the electrode of the present disclosure at 800° C. is equal to or less than 1%/h. If manufacturing conditions are further optimized, the degradation rate at 800° C. is equal to or less than 0.5%/h.

This similarly applies to when the electrolyte particles are a mixture of GDC and La-GDC. When the composition is optimized, an electrode having a slow degradation rate is obtained.

### 1. 6. Intended Use

The SOEC and the SOFC typically include an electrolyte layer that contains a solid oxide electrolyte, a fuel electrode coupled to one surface of the electrolyte layer, an air electrode coupled to another surface of the electrolyte layer, and an intermediate layer (anti-reaction layer) inserted between the electrolyte layer and the air layer.

In addition, a fuel-electrode-side collection layer may be disposed on an outer side of the fuel electrode or an air-electrode-side collection layer may be disposed on an outer side of the air electrode.

In particular, the electrode of the present disclosure is suitable as a fuel electrode for the SOEC or a fuel electrode for the SOFC.

When the electrode of the present disclosure is used as the fuel electrode for the SOEC or the fuel electrode for the SOFC, materials of other constituent elements are not particularly limited and optimal materials can be selected based on intended purpose.

For example, in the solid oxide electrolyte composing the electrolyte layer, yttria-stabilized zirconia (YSZ), scandia-stabilized zirconia (ScSZ), scandia-yttria-stabilized zirconia (ScYSZ), samaria-doped ceria (SDC), lanthanum strontium gallium magnesium oxide (LSGM), and the like can be used.

In the air electrode, lanthanum strontium manganite (LSM), lanthanum strontium cobalt ferrite (LSCF), lanthanum strontium cobaltite (LSC), and the like can be used.

The intermediate layer prevents reaction that occurs when the electrolyte layer and the air electrode come into direct contact, and is inserted as required. For example, when the electrolyte layer is YSZ and the air electrode is LSC, Gd-doped CeO₂ (GDC) is preferably used in the intermediate layer.

The materials of the fuel-electrode-side collection layer and the air-electrode-side collection layer are not particularly limited as long as the materials enable transfer of electrons, supply of reactants, and discharge of reaction products. A material having an identical or similar composition as the electrode and higher porosity than the electrode is ordinarily used in the collection layer.

### 2. Electrode Manufacturing Method

The electrode of the present disclosure can be manufactured by:
(a) a molding being fabricated using a raw material mixture containing raw materials of the Ni-based particles and raw materials of the electrolyte particles;
(b) sintering the obtained molding;
(c) performing a reduction treatment on the obtained sintered body; and
(d) performing an oxidation treatment on the obtained reduced body in a controlled oxidation atmosphere.

### 2. 1. Molding Formation Step

First, the molding is fabricated using the raw material mixture containing the raw materials for the Ni-based particles and the raw materials for the electrolyte particles.

The “raw materials for the Ni-based particles” refer to the raw materials that form the Ni-based particles after sintering, reduction, and controlled oxidation treatment. In the present disclosure, a type of raw material of the Ni-based particles is not particularly limited and the optimal raw materials can be selected based on intended purpose. For example, as the raw materials for the Ni-based particles, NiO powder, Fe₂O₃ powder, Fe₃O₄ powder, a mixture of metal Fe and NiO or metal Ni, CoO powder, and CO₂O₃ powder can be used.

The “raw materials for the electrolyte particles” refer to the raw materials that form the electrolyte particles after sintering, reduction, and controlled oxidation treatment. In the present disclosure, GDC powder and/or La-GDC powder is used as the raw material for the electrolyte particles. The compositions of the GDC and La-GDC are as described above. Therefore, descriptions thereof are omitted.

The raw material mixture may contain a pore forming material (such as carbon powder). The metal oxide (such as the NiO powder) contained in the raw materials for the Ni-based particles added to the raw material mixture undergoes the reduction treatment after fabrication of the sintered body. At this time, volume contraction occurs and pores are introduced into the sintered body. Therefore, the pore forming material is not necessarily required. However, if the pore forming material is added to the raw material mixture, freedom of control of porosity increases.

Furthermore, the raw materials are preferably formulated so that the fuel electrode having the target composition after sintering, reduction, and controlled oxidation treatment can be obtained.

A fabrication method for the molding is not particularly limited and the optimal method can be selected based on intended purpose. For example, as the fabrication method for the molding,
(a) a method in which a slurry containing the raw material mixture is tape-molded, an obtained green sheet is laminated onto a base material (such as a molding that serves as the fuel-electrode-side collection layer after sintering or a molding that serves as the electrolyte layer after sintering), and the laminated body is pressed by hydrostatic pressure; and
(b) a method in which a slurry containing the raw material mixture is fabricated and the slurry is screen-printed onto the surface of the base material can be given.

### 2.2. Sintering Step

Next, the obtained molding is sintered (sintering step). Optimal sintering conditions are preferably selected based on the raw material composition. Sintering is ordinarily preferably performed in an air atmosphere for one to five hours at 1000° C. to 1500° C. (preferably 1000° C. to 1300° C.). When the raw material mixture contains the pore forming material, the pore forming material is burned away during sintering and pores are formed in the sintered body.

### 2.3. Reduction Step

Next, the obtained sintered body undergoes the reduction treatment (reduction step). The reduction treatment is performed to reduce metal oxide such as NiO contained in the sintered body and produce Ni-based particles (that is, the core particles) that are in the metal state. Reduction conditions are not particularly limited as long as the conditions enable the core particles to be produced.

### 2.4. Oxidation Step

Next, the obtained reduced body undergoes the oxidation treatment in a controlled oxidation atmosphere. As a result, the electrode of the present disclosure is obtained. The controlled oxidation treatment is performed to form the shell on the surfaces of the core particles. Conditions for the controlled oxidation treatment are not particularly limited as long as only a surface layer portion of the core particles can be selectively oxidized.

As a method for forming the core-shell particles, following methods can be given.

In a first method,
(a) a cell in which an electrode immediately after reduction (an electrode containing the core particles) is used as the fuel electrode is fabricated;
(b) a gas atmosphere on the fuel electrode side is adjusted to H₂O/H₂=4 (volume ratio) in a state in which the cell is heated to a temperature equal to or higher than 650° C.;
(c) a current of 30 mA is applied to the cell in this state for at least 50 hours; and
(d) after application of the current is stopped, an interior of the fuel electrode is filled with an inert gas (such as N₂ gas).

In a second method,
(a) a cell in which an electrode immediately after reduction (an electrode containing the core particles) is used as the fuel electrode is fabricated;
(b) a gas atmosphere on the fuel electrode side is adjusted to H₂O/H₂=1.0 or greater (volume ratio) in a state in which the cell is heated to a temperature equal to or higher than 400° C.;
(c) the cell is held for at least an hour without a current being applied; and
(d) after holding, the fuel electrode is filled with an inert gas (such as N₂ gas) and held in this state.

In the present disclosure, either method can be used. Regardless of the method used, the area ratio of the shell can be controlled through optimization of the temperature, atmosphere, current, treatment time, and the like.

Here, as described above, the electrolysis cell is composed of a coupled body of the fuel electrode (cathode)/electrolyte layer/anti-reaction layer/air electrode (anode). In addition, the fuel-electrode-side collection layer may be further coupled on the outer side of the fuel electrode. In addition or instead of the foregoing, the air-electrode-side collection layer may be further coupled on the outer side of the air electrode. Sintering and coupling of the layers are performed after lamination of the molding, by the laminated body being heated to a predetermined temperature. Furthermore, if the optimal sintering temperature differs among the layers, sintering is ordinarily performed divided into a plurality of stages. Furthermore, reduction of the fuel electrode is ordinarily performed after all layers are coupled.

When the electrode of the present disclosure is used as the fuel electrode of the electrolysis cell, the controlled oxidation treatment on the fuel electrode is performed after all layers are coupled and the fuel electrode undergoes the reduction treatment.

### 3. Workings

### 3.1. Degradation of the Electrode

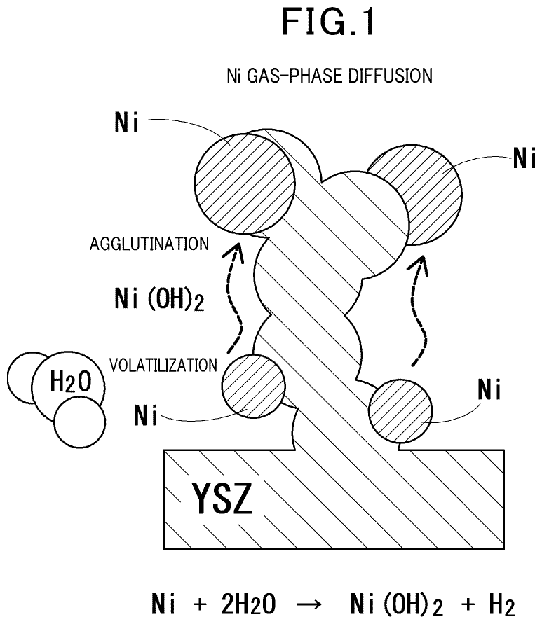

FIG. 1 shows a schematic diagram of electrode degradation in a conventional fuel electrode. In a conventional electrolysis cell in which Ni/YSZ is used in the fuel electrode, degradation over time of the fuel electrode is thought to occur as a result of gas-phase diffusion of Ni.

Degradation over time of the fuel electrode due to gas-phase diffusion of Ni is thought to progress in a following manner. That is, as shown in FIG. 1, first, when the fuel electrode is exposed to high-temperature steam, Ni reacts with the steam and nickel hydroxide is produced. The produced nickel hydroxide or decomposition products thereof are diffused within the electrode via the gas phase and agglutinate on the surfaces of the larger Ni particles. As a result, the morphology of electrode reaction sites changes and the electrode is thought to thereby degrade.

### 3.2. Maintenance of Electrode Activity by Core-Shell Particles

In contrast, in the electrode that contains the electrolyte particles composed of GDC and/or La-GDC and the Ni-based particles, if the shell composed of a composite oxide containing NiO or Ni (Ni-based oxide) is formed on the surfaces of the Ni-based particles in advance, degradation over time of the electrode can be suppressed without compromising electrode performance. This is thought to be for the following reasons.

### 3.2.1. Maintenance of Electrode Reaction Sites by GDC and La-GDC

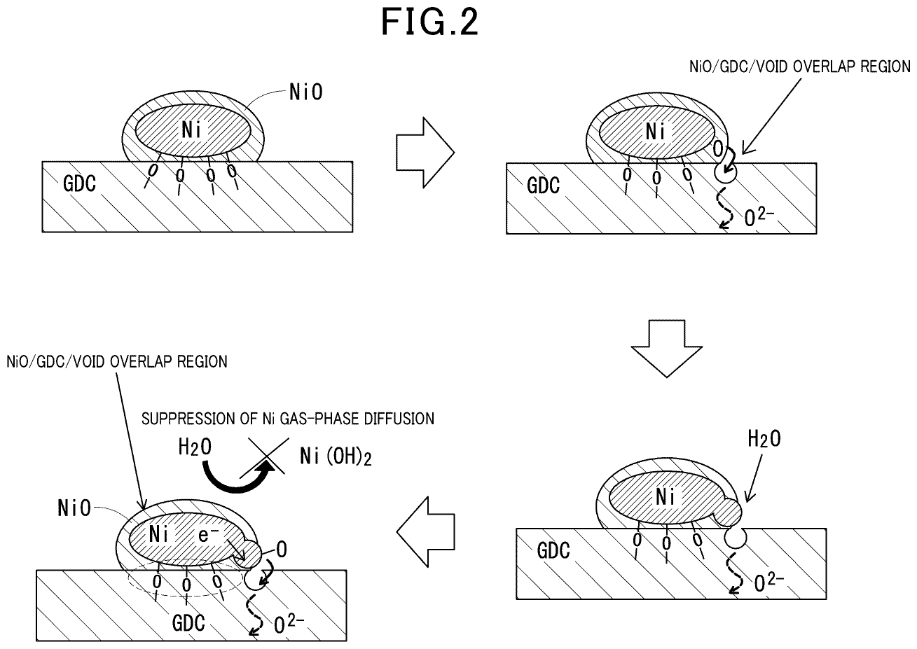

FIG. 2 shows a schematic diagram of a process in which electrode activity is maintained by the Ni-based particles having the core-shell structure. First, when the electrode containing pure Ni particles and GDC undergoes the oxidation treatment in a controlled oxidation atmosphere, only the surface portions of the pure Ni particles are selectively oxidized. As a result, the core-shell particles in which the surfaces of the cores composed of pure Ni are covered are obtained. See an upper left-hand drawing in FIG. 2.

GDC has oxygen storage capacity. Therefore, in a “region in which NiO/GDC/void overlap (three-phase interface),” GDC extracts oxygen from NiO. As a result, in the vicinity of the three-phase interface, NiO may be reduced to metal Ni. However, in other regions, the surfaces of the cores mostly remain covered by NiO. See the upper right-hand drawing and lower right-hand drawing in FIG. 2.

When a current is applied to the electrode (such as during electrolytic operation), the oxygen stored in GDC is diffused within GDC and form lattice vacancies that serve as an origin of oxygen storage capacity. As a result, even when the electrode is exposed to high-temperature steam, in the “region in which NiO/GDC/void overlap,” the Ni layer is formed at all times and function as the electrode reaction site is continued. See a lower left-hand drawing in FIG. 2.

This also similarly applies
(a) when the electrolyte particles are La-GDC or a mixture of GDC and La-GDC, or
(b) when the cores of the Ni-based particles are composed of an Ni-based alloy and the shell is composed of a composite oxide containing Ni.

### 3.2.2. Suppression of Morphological Changes in the Electrode Reaction Site by the Shell

Gas-phase diffusion of Ni is thought to occur as a result of Ni coming into direct contact with high-temperature steam. In contrast, when the surfaces of Ni in a region other than the vicinity of the three-phase interface are covered by NiO, in the region (that is, a “region in which NiO and a void overlap”), production of nickel oxide that causes electrode degradation is suppressed. As a result, gas-phase diffusion of Ni is thought to be suppressed. See the lower left-hand drawing in FIG. 2.

This also similarly applies when the cores of the Ni-based particles are a Ni-based alloy and the shell is a composite oxide containing Ni.

In the electrode composed of the Ni-based particles and GDC and/or La-GDC, the electrode functions as an electrode even in cases in which the Ni-based particles do not have the shell. However, when the Ni-based particles do not have the shell, if the electrode is used under harsh conditions immediately after start of use, morphological changes in the electrode reaction sites may excessively progress. In contrast, the risk of such issues is minimal when the Ni-based particles have the shell.

### 3.3. Effects of La

The electrode containing La-GDC exhibits higher durability than the electrode containing only GDC. This is thought to be because the oxygen storage capacity increases as a result of a portion of Gd contained in GDC being replaced with La.

### EXAMPLES

### A. Experiment 1

### 1. Fabrication of the Electrolysis Cell

### 1.1. Sample No. 1

A GDC sheet (anti-reaction layer, diameter: 22 mm) was placed over one surface of an 8YSZ electrolyte pellet (diameter: 22 mm and thickness: 500 μm) to which a reference electrode is attached to a side surface thereof, and sintered at 1380° C.

Next, the fuel electrode was formed on another surface of the 8YSZ electrolyte pellet (a surface opposite the surface on which the anti-reaction layer was baked). That is, a NiO/GDC paste (mass ratio of NiO:GDC=1:1) was applied by a screen-printing method and sintered at 1340° C. A GDC powder having a Gd content of 10 mol % was used.

Furthermore, a LSC/GDC paste was applied by a screen-printing method on the anti-reaction layer and sintered at 1125° C., thereby forming the air electrode.

The obtained electrolysis cell underwent the reduction treatment for the fuel electrode. The reduction treatment was performed by the obtained electrolysis cell being held in a 100% hydrogen atmosphere for 20 minutes at 700° C.

### 1.2. Sample No. 2

An electrolysis cell was fabricated in a manner similar to the sample No. 1, aside from the fuel electrode being fabricated using a NiO/8YSZ paste.

### 2. Test Method

### 2.1. Degradation Rate

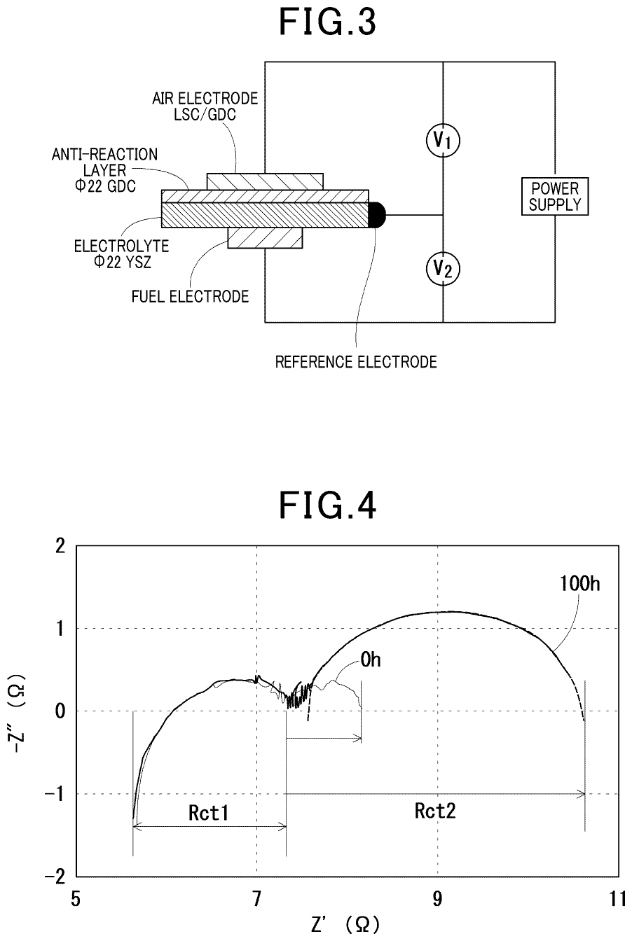

FIG. 3 shows a schematic diagram of an electrolysis cell used for impedance measurement. A reference electrode is coupled to a side surface of the electrolyte layer. The reference electrode is used to measure a voltage Vi across the electrolyte layer and the air electrode and a voltage V₂ across the electrolyte layer and the fuel electrode. As a result of the reference electrode being coupled to the electrolyte layer, the fuel electrode and the air electrode can be separately evaluated.

A steam electrolysis test (durability test) of 100 h was performed under conditions shown in Table 1 using the electrolysis cell shown in FIG. 3. During the durability test, impedance measurement was performed and the electrode reaction resistance (Rct2) was measured. In addition, the resistance change ratio expressed by expression (1) was calculated using the electrode reaction resistances (Rct2) before the durability test and after the durability test was performed for a predetermined amount of time. Furthermore, the degradation rate was calculated from the resistance change ratio.

### 2.2. Shell Area Ratio

SEM observation and EDS mapping were performed on a cross-section of the fuel electrode before the durability test and after 100 hours of the durability test. Based on the result of EDS mapping, the area of each constituent material contained in the fuel electrode was calculated and the area ratio thereof was determined. A calculation process for the area ratio is as follows.

That is, the cross-section of the electrode was observed in a region at 2,000 to 3,500 magnification and the electrode cross-section was divided into eight areas (thickness: 5 μm) along the thickness direction. For each area, the Ni (core) area ratio, the NiO area ratio, the void area ratio, and the electrolyte area ratio were calculated.

Next, for each area, an average value of the area ratios of each constituent material was calculated. Furthermore, using the “average value of the area ratios of each constituent material” calculated for each area, the “average value of the area ratios of each constituent material” of the overall electrode was calculated.

### 2.3. TEM/EDS Analysis

A TEM/EDS analysis was performed on the fuel electrode after the durability test.

### 3. Results

### 3.1. Degradation Rate

FIG. 4 shows an example of impedance analysis results. In FIG. 4, a second arc (Rct2) indicates a magnitude of an electrochemical reaction resistance of the fuel electrode. It is indicated that, as the diameter of the second arc increases, the electrochemical reaction resistance increases. An arc to the left of the second arc is a first arc (Rct1) and indicates a magnitude of resistance of an electrolyte ion path within a hydrogen electrode.

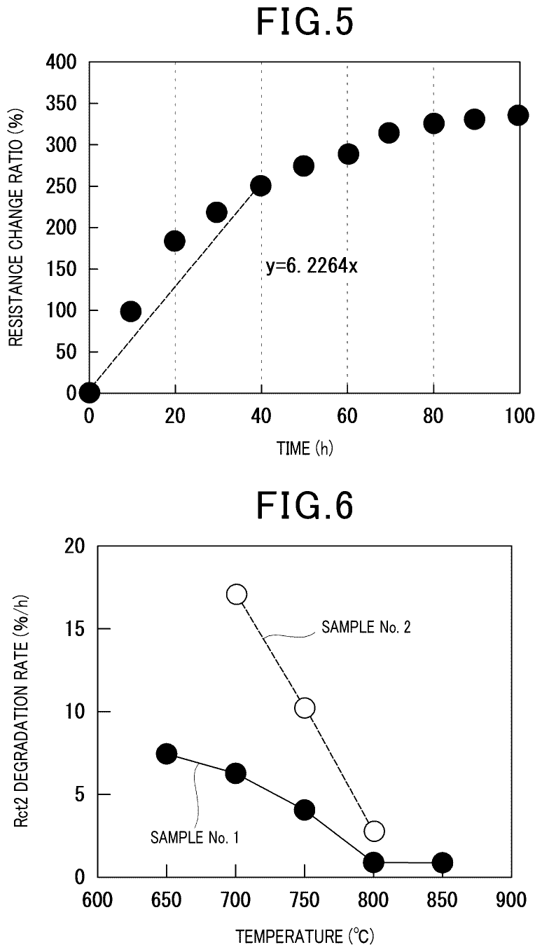

FIG. 5 shows an example of changes over time in the resistance change ratio of sample No. 1. From FIG. 5, it is clear that a speed of change of the resistance change ratio decreases when the durability test time exceeds 40 hours.

FIG. 6 shows the degradation rates of sample No. 1 and sample No. 2 at each temperature. In the case of sample No. 1, the degradation rate at each temperature is 7.44%/h (650° C.), 6.22%/h (700° C.), 3.99%/h (750° C.), 0.86%/h (800° C.), and 0.79%/h (850° C.). It is clear from FIG. 6 that the degradation rate of sample No. 1 is about half that of sample No. 2. In addition, this result is thought to indicate that, when the fuel electrode immediately after manufacturing undergoes the oxidation treatment in a controlled oxidation atmosphere and the Ni-based particles are formed to have the core-shell structure in advance, degradation of the Ni-based particles during electrolysis is suppressed.

### 3.2. Shell Area Ratio

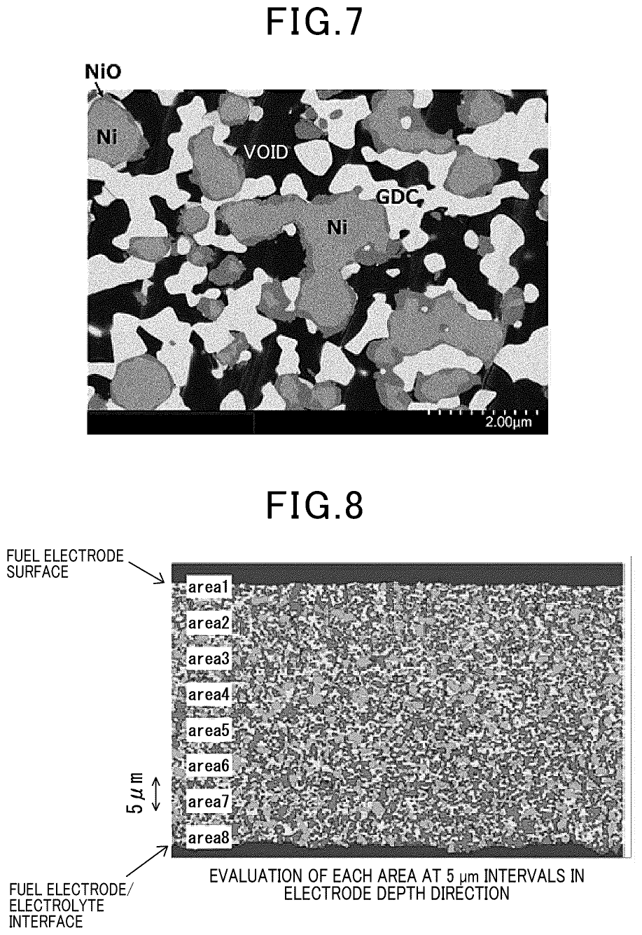

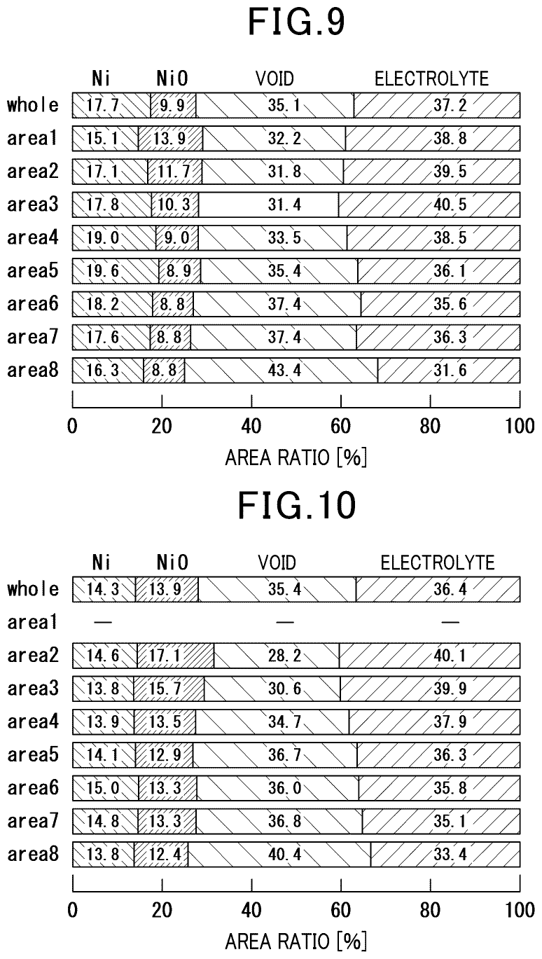

FIG. 7 shows an SEM image of an electrode cross-section (partial) of sample No. 1 after a durability test (800° C.). FIG. 8 shows an example of SEM/EDS mapping of an electrode cross-section (full, from the electrolyte interface to the electrode surface) of sample No. 1 after a durability test (800° C.). FIG. 9 shows the area ratios of the electrode constituent materials of sample No. 1 after a durability test (800° C.). Furthermore, FIG. 10 shows the area ratios of the electrode constituent materials of sample No. 1 after a durability test (850° C.).

In the case of sample No. 1, the ratio of the Ni particles (core) and the NiO layer (shell) in the full electrode cross-section after the durability test (800° C.) is 17.7:9.9 (=1:0.056). See “whole” in the top row in FIG. 9. In addition, the ratio of the Ni particles (core) and the NiO layer (shell) in the full electrode cross-section after the durability test (850° C.) is 14.3:13.9 (=1:0.97). See “whole” in the top row in FIG. 10.

In addition, an area actually working as the electrode reaction site is a region (areas 5 to 8 in FIG. 8 to FIG. 10) up to 20 μm from the fuel electrode/electrolyte interface. The ratio of the Ni particles (core) and the NiO layer (shell) in this region after the durability test (800° C.) is 17.9:8.8 (=1:0.49). In addition, the ratio of the Ni particles (core) and the NiO layer (shell) in this region after the durability test (850° C.) is 14.4:13.0 (=1:0.90).

### 3.3. TEM/EDS Analysis

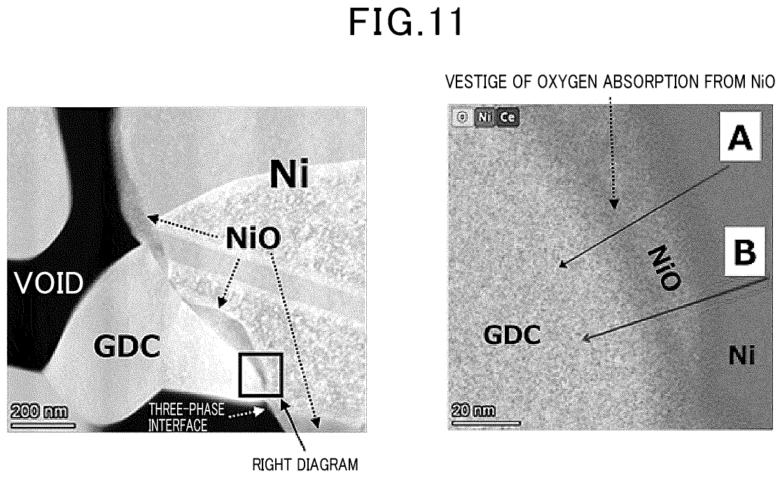

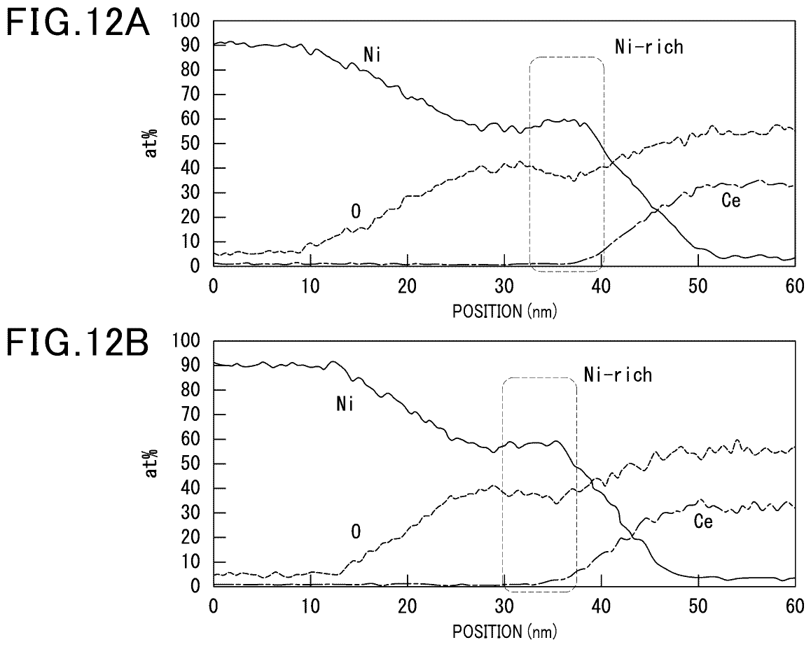

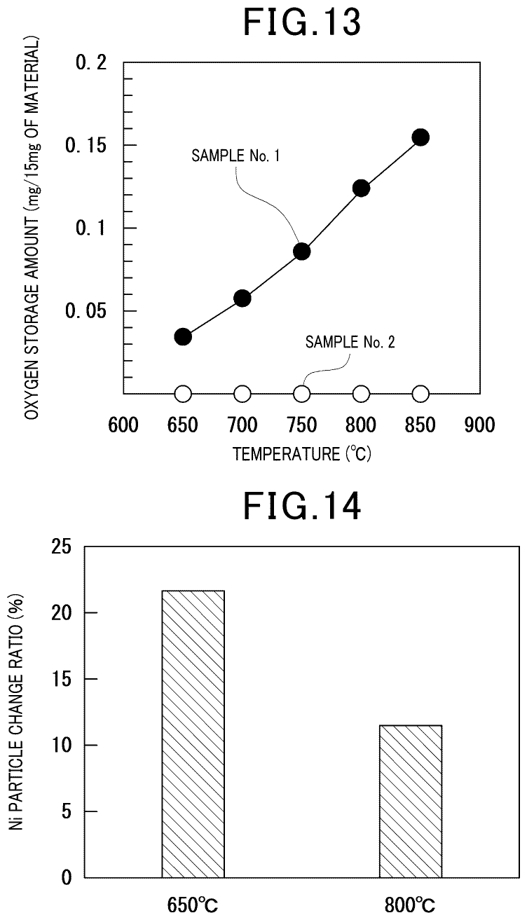

FIG. 11 shows a TEM image (left-hand diagram) and an EDS mapping (right-hand diagram) of the electrode of sample No. 1 after a durability test (800° C.). FIG. 12A shows line analysis results when line analysis is performed along an arrow A direction in FIG. 11. FIG. 12B shows line analysis results when line analysis is performed along an arrow B direction in FIG. 11. Furthermore, FIG. 13 shows the oxygen storage capacities of the electrodes of sample No. 1 and sample No. 2 at each temperature.

As shown in the left-hand diagram in FIG. 11, the NiO layer was confirmed in each of the Ni particle/gas-phase interface and the Ni particle/GDC particle interface. However, the thickness was not consistent in either of the NiO layer formed in the Ni particle/gas-phase interface and the NiO layer formed in the Ni particle/GDC particle interface. It is clear from FIG. 11 that an area in which the thickness of the NiO layer is significantly thin is present in the vicinity of the three-phase interface.

In the case of sample No. 1, a Ni-rich layer (approximately 5 nm level) was confirmed within the NiO region in the vicinity of the three-phase interface (electrode reaction site). See FIG. 12. This Ni-rich layer is thought to be a vestige of absorption of oxygen from NiO by GDC.

This result suggests that the NiO layer is in a Ni-rich state as a result of GDC absorbing the oxygen from within the NiO layer (see FIG. 13). In addition, this is thought to also indicate that, even when the Ni-based particles are exposed to high-temperature steam, the function as the electrode reaction site is maintained on the surface of the Ni-based particles.

FIG. 14 shows a Ni particle change ratio of the electrode of sample No. 1 at each temperature. The “Ni particle change ratio” refers to a proportion of changes in an average particle diameter of the Ni particles before and after the durability test. It is clear from FIG. 14 that the Ni particle change ratio decreases as the temperature during the durability test increases.

This result is thought to indicate that, if the treatment temperature of the controlled oxidation treatment is increased, the shell is more easily formed on the surface of the Ni-based particles.

In addition, this result is thought to also indicate that, if the treatment temperature of the controlled oxidation treatment is increased, morphological changes in the three-phase interface can be suppressed and electrode activity can be more easily maintained as a result of Ni(OH)₂ production being suppressed.

### B. Experiment 2

### 1. Electrolysis Cell Fabrication

### 1.1. Sample No. 3

The anti-reaction layer was formed on one surface of an 8-YSZ electrolysis pellet in a manner similar to sample No. 1. Using La-GDC as an electrolyte powder for the fuel electrode, a NiO/La-GDC paste (NiO: La-GDC =36:64 mass ratio) paste was applied to the other surface of the 8YSZ electrolyte pellet by a screen-printing method. Hereafter, the electrolysis cell was fabricated in a manner similar to sample No. 1. The La-GDC powder having a La content of 5 mol % and a Gd content of 5 mol % was used.

### 2. Test Method

### 2.1. Degradation Rate

Measurement of the electrode reaction resistance (Rct2), calculation of the resistance change ratio, and calculation of the degradation rate were performed in a manner similar to sample No. 1.

### 2.2. Shell Area Ratio

The area ratio of the shell was determined in a manner similar to sample No. 1.

### 3. Results

### 3.1 Degradation Rate

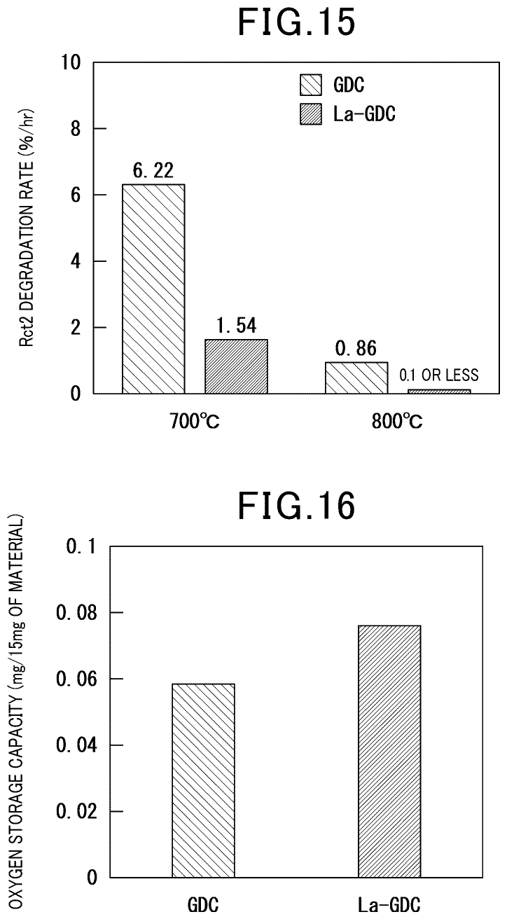

FIG. 15 shows the degradation rates of the electrodes of sample No. 3 (La-GDC) and sample No. 1 (GDC) at each temperature. It is clear from FIG. 15 that the degradation rate of sample No. 3 is equal to or less than half that of sample No. 1.

FIG. 16 shows the oxygen storage capacities of La-GDC and GDC. It is clear from FIG. 16 that the oxygen storage capacity of La-GDC is higher than that of GDC. The durability of sample No. 3 is thought to have significantly increased from that of sample No. 1 as a result of the improvement in oxygen storage capacity due to a portion of Gd contained in GDC being replaced with La.

### 3.2. Shell Area Ratio

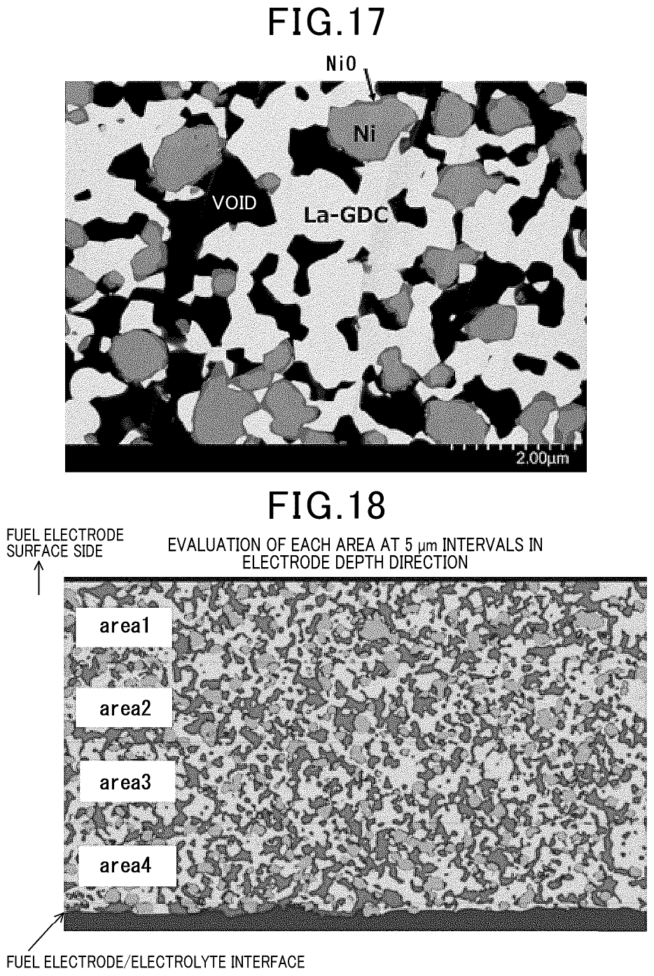

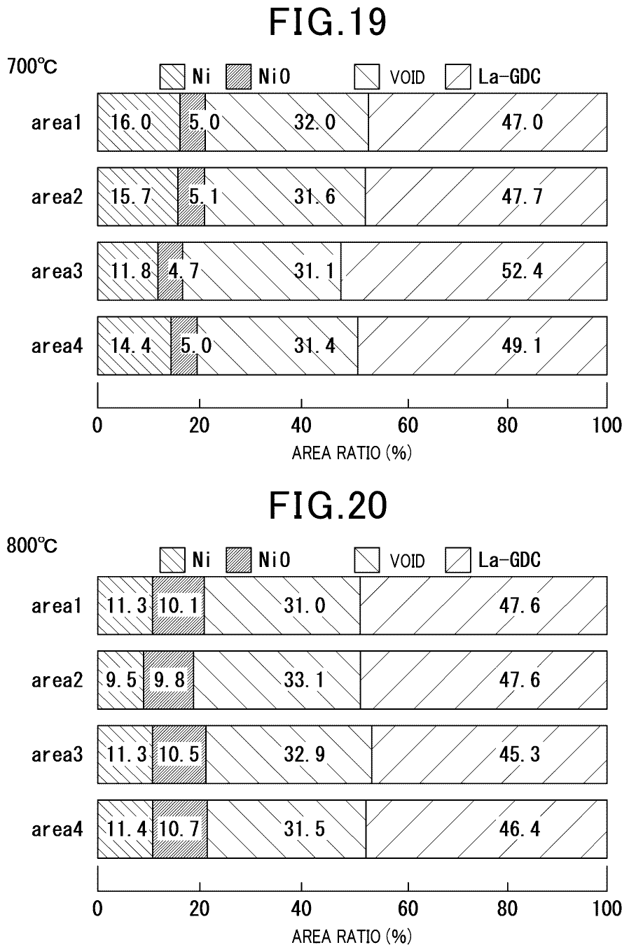

FIG. 17 shows an SEM image of an electrode cross-section (partial) of sample No. 3 after a durability test (700° C.). FIG. 18 shows an example of SEM/EDS mapping of an electrode cross-section (an area from the electrolyte interface to about 20 μm toward the electrode surface side) of sample No. 3 after a durability test (700° C.). FIG. 19 shows the area ratios of the electrode constituent materials of sample No. 3 after a durability test (700° C.). Furthermore, FIG. 20 shows the area ratios of the electrode constituent materials of sample No. 3 after a durability test (800° C.).

In the case of sample No. 3, the ratio (average value) of the Ni particles (core) and the NiO layer (shell) after the durability test (700° C.) was 14.5:5.0 (=1:0.34). In addition, the ratio (average value) of the Ni particles (core) and the NiO layer (shell) after the durability test (800° C.) was 10.9:10.3 (=1:0.94).

An embodiment of the present disclosure is described in detail above. However, the present disclosure is not limited in any way to the above-described embodiment and various modifications are possible without departing from the spirit of the present disclosure.

The electrode of the present disclosure can be used as a fuel electrode for a SOEC or a fuel electrode for a SOFC.

Characteristic configurations extracted from the above-described embodiments and variation examples are described below.

### Configuration 1

An electrode including electrolyte particles and Ni-based particles, in which the electrolyte particles contain Gd-doped CeO₂ (GDC) and/or Gd- and La-doped CeO₂ (La-GDC), and the Ni-based particles are composed of core-shell particles in which a surface of a core composed of Ni or a Ni-based alloy is partially or fully covered by a shell composed of a composite oxide containing NiO or Ni.

### Configuration 2

The electrode according to Configuration 1 in which an area ratio of the shell is greater than 0 and equal to or less than 0.98, where the area ratio of the shell refers to a ratio (Sₛₕₑₗₗ/S_{core}) of an area (Sₛₕₑₗₗ) of the shell to an area (S_{core}) of the core in a cross-section of the electrode.

### Configuration 3

The electrode according to Configuration 1 or 2 in which the shell includes an area having a thickness that is equal to or less than 200 nm.

### Configuration 4

The electrode according to any one of Configurations 1 to 3, in which a degradation rate at 700° C. is equal to or less than 10%/h, where the degradation rate refers to a slope A of a straight line ΔR=A×t determined by setting a vertical axis to a resistance change ratio ΔR (%) of the electrode before and after a durability test and a horizontal axis to a durability test time t (h), and connecting values at t=0 h and 40 h.

### Configuration 5

The electrode according to any one of Configurations 1 to 4, in which GDC has a Gd content of greater than 0 mol % and equal to or less than 20 mol %, where the Gd content refers to a proportion of Gd in number of mols relative to a total number of mols of Ce and Gd contained in GDC.

### Configuration 6

The electrode according to any one of Configurations 1 to 5, in which La-GDC has a Gd content of greater than 0 mol % and less than 10 mol %, and a La content of greater than 0 mol % and less than 10 mol %, where the Gd content refers to a proportion of Gd in number of mols relative to a total number of mols of Ce, Gd, and La contained in GDC and the “La content” refers to a proportion of La in number of mols relative to the total number of mols of Ce, Gd, and La contained in GDC.

### Configuration 7

The electrode according to any one of Configurations 1 to 6 in which a Ni-based particle content is equal to or greater than 30 mass % and equal to or less than 70 mass %, where the Ni-based particle content refers to a proportion of Ni-based particles by mass relative to a total mass of the electrolyte particles and the Ni-based particles.

### Configuration 8

The electrode according to any one of Configurations 1 to 7, in which porosity of the electrode is equal to or greater than 20% and equal to or less than 40%, where the porosity refers to a value measured by a mercury porosity meter.

### Configuration 9

The electrode according to any one of Configurations 1 to 8 in which the electrode is used as a fuel electrode for a solid oxide electrolyzer cell (SOEC) or a fuel electrode for a solid oxide fuel cell (SOFC).

What is claimed is:

1. An electrode comprising:
electrolyte particles; and
Ni-based particles, wherein
the electrolyte particles contain Gd-doped CeO₂ (GDC) and/or Gd- and La-doped CeO₂ (La-GDC), and
the Ni-based particles are composed of core-shell particles in which a surface of a core composed of Ni or a Ni-based alloy is partially or fully covered by a shell composed of a composite oxide containing NiO or Ni.

2. The electrode according to claim 1, wherein:
an area ratio of the shell is greater than 0 and equal to or less than 0.98,
where the area ratio of the shell refers to a ratio (Sₛₕₑₗₗ/S_{core}) of an area (Sₛₕₑₗₗ) of the shell to an area (S_{core}) of the core in a cross-section of the electrode.

3. The electrode according to claim 1, wherein:
the shell includes an area having a thickness that is equal to or less than 200 nm.

4. The electrode according to claim 1, wherein:
a degradation rate at 700° C. is equal to or less than 10%/h,
where the degradation rate refers to a slope A of a straight line ΔR=A×t determined by setting a vertical axis to a resistance change ratio ΔR (%) of the electrode before and after a durability test and a horizontal axis to a durability test time t (h), and connecting values at t=0 h and 40 h.

5. The electrode according to claim 1, wherein:
GDC has a Gd content of greater than 0 mol % and equal to or less than 20 mol %,
where the Gd content refers to a proportion of Gd in number of mols relative to a total number of mols of Ce and Gd contained in GDC.

6. The electrode according to claim 1, wherein:
La-GDC has a Gd content of greater than 0 mol % and less than 10 mol %, and a La content of greater than 0 mol % and less than 10 mol %,
where the Gd content refers to a proportion of Gd in number of mols relative to a total number of mols of Ce, Gd, and La contained in GDC and the La content refers to a proportion of La in number of mols relative to the total number of mols of Ce, Gd, and La contained in GDC.

7. The electrode according to claim 1, wherein:
a Ni-based particle content is equal to or greater than 30 mass % and equal to or less than 70 mass %,
where the Ni-based particle content refers to a proportion of Ni-based particles by mass relative to a total mass of the electrolyte particles and the Ni-based particles.

8. The electrode according to claim 1, wherein:
porosity of the electrode is equal to or greater than 20% and equal to or less than 40%,
where the porosity refers to a value measured by a mercury porosity meter.

9. The electrode according to claim 1, wherein:
the electrode is used as a fuel electrode for a solid oxide electrolyzer cell (SOEC) or a fuel electrode for a solid oxide fuel cell (SOFC).
